(19) United States
(12) Patent Application Publication
(10) Pub. No.: US 2010/0066660 A1
(43) Pub. Date: Mar. 18, 2010

(54) SCANNING DRIVING APPARATUS FOR BACKLIGHT SOURCE AND LIQUID CRYSTAL DISPLAY USING THE SAME

(75) Inventors: Chang-Xin Huang, Taipei City (TW); Chao-Wei Wei, Taoyuan County (TW); Shih-Hen Chao, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/264,237

(22) Filed: Nov. 3, 2008

(30) Foreign Application Priority Data
Sep. 15, 2008 (TW) 97135343

(51) Int. Cl. G09G 3/36

(52) U.S. Cl. 345/102

(57) ABSTRACT

A scanning backlight source driving apparatus and a liquid crystal display using the same are provided, wherein the scanning backlight source driving apparatus includes a DC/AC inverter, N transformers, N switches, and a control circuit, where N is a natural number. The DC/AC inverter has a first output terminal and a second output terminal configured to output an AC voltage. Each transformer has a primary winding. Each switch electrically connects the first output terminal to the second output terminal through a corresponding one of the primary windings. The control circuit is configured to control periodic and temporary turn-on or turn-off on the switches in a predetermined sequence.

### CROSS-REFERENCE TO RELATED APPLICATION

This application claims the priority benefit of Taiwan application serial no. 97135343, filed on Sep. 15, 2008. The entirety of the above-mentioned patent application is hereby incorporated by reference herein and made a part of specification.

### BACKGROUND OF THE INVENTION

1. Field of the Invention

The present invention generally relates to liquid crystal displays, and more particularly, to a scanning driving apparatus for a backlight source that needs only one DC/AC inverter, and a liquid crystal display thereof.

2. Description of Related Art

Nowadays, cold cathode fluorescent lamps (CCFLs) are still being widely used as a backlight source for liquid crystal displays (LCDs). If the CCFLs are all turned on, image persistence can occur during an LCD displaying dynamic images. Therefore, newer LCDs typically use a scanning driving method instead to drive these lamps to improve quality of dynamic images. In other words, these lamps are turned on alternatively. As such, by simulating the light emission of cathode ray tubes (CRTs) with impulse type, the LCD can hide the image persistence of the LCD in dark regions where CCFLs are turned off.

FIG. 1 illustrates a conventional scanning driving apparatus for a backlight source disclosed in U.S. Pat. No. 6,778,415. As shown in FIG. 1, the scanning backlight source driving apparatus includes a plurality of DC/AC inverters (as indicated by 10˜16) and a plurality of transformers (as indicated by 110) corresponding to the DC/AC inverters. In addition, the scanning backlight source driving apparatus further includes a control circuit 40 to control operation of the transformers. The control circuit 40 includes a pulse generator 46 and a phase selector 44. A primary winding, as indicated by 112, of each transformer is used to receive an AC voltage outputted from a corresponding DC/AC inverter and a secondary winding, as indicated by 114, of each transformer is used to connect to a load, i.e., the CCFL. The CCFLs can thus be turned on alternatively by the transformers as long as the DC/AC inverters alternatively output AC voltage.

While this scanning backlight source driving apparatus can drive the CCFLs with a scanning driving method to alleviate image persistence, it can be seen from its circuit structure that each transformer needs to be used in combination with a separate DC/AC inverter. As such, the circuit has a large size as well as a high cost.

### SUMMARY OF THE INVENTION

Accordingly, the present invention is directed to a scanning driving apparatus for a backlight source that needs only one DC/AC inverter thereby significantly reducing size and cost of the circuit.

The present invention is also directed to a liquid crystal display that uses the scanning backlight source driving apparatus which needs only one DC/AC inverter, such that the cost of the liquid crystal display can be reduced.

The present invention provides a scanning driving apparatus for a backlight source. The scanning backlight source driving apparatus includes a DC/AC inverter, N transformers, N switches, and a control circuit, where N is a natural number. The DC/AC inverter has a first output terminal and a second output terminal configured to output an AC voltage. Each transformer has a primary winding. Each switch electrically connects the first output terminal to the second output terminal through a corresponding one of the primary windings. The control circuit is configured to control periodic and temporary turn-off on the switches in a predetermined sequence.

The present invention additionally provides a scanning driving apparatus for a backlight source. The scanning backlight source driving apparatus includes a DC/AC inverter, N transformers, N switches, and a control circuit, where N is a natural number. The DC/AC inverter has a first output terminal and a second output terminal configured to output an AC voltage. Each transformer has a primary winding. Each switch is configured to determine whether to electrically connect the first output terminal to the second output terminal through a corresponding one of the primary windings. The control circuit is configured to control periodic and temporary turn-on on the switches in a predetermined sequence.

The present invention further provides a liquid crystal display including a display panel as well as one of the two scanning backlight source driving apparatus described above.

According to one embodiment of the present invention, the switches are implemented as electronic switch elements or mechanical switch elements.

According to one embodiment of the present invention, the electronic switch element includes a bilateral switch and the mechanical switch element includes a relay.

The scanning backlight source driving apparatus includes a DC/AC inverter, N transformers, N switches, and a control circuit. Turn-on/turn-off on each of the switches is used to determine whether to transmit an AC voltage outputted from the DC/AC inverter to the primary winding of a corresponding one of the transformers. By using the control circuit to control turn-on/turn-off on the switches, the backlight source can be driven with a scanning driving method, and the whole circuit needs only one DC/AC inverter, thereby significantly reducing the size and cost of the circuit. Besides, if a liquid crystal display employs the scanning backlight source driving apparatus described above, the cost of the liquid crystal display can be significantly reduced.

In order to make the aforementioned and other features and advantages of the present invention more comprehensible, embodiments accompanied with figures are described in detail below.

### BRIEF DESCRIPTION OF THE DRAWINGS

FIG. 1 illustrates a conventional scanning driving apparatus for a backlight source.

FIG. 2 illustrates a scanning driving apparatus for a backlight source according to one embodiment of the present invention.

FIG. 3 illustrates one sequence of the control signals C1˜C4 of FIG. 2.

FIG. 4 illustrates another sequence of the control signals C1˜C4 of FIG. 2.

FIG. 5 illustrates a scanning driving apparatus for a backlight source according to another embodiment of the present invention.

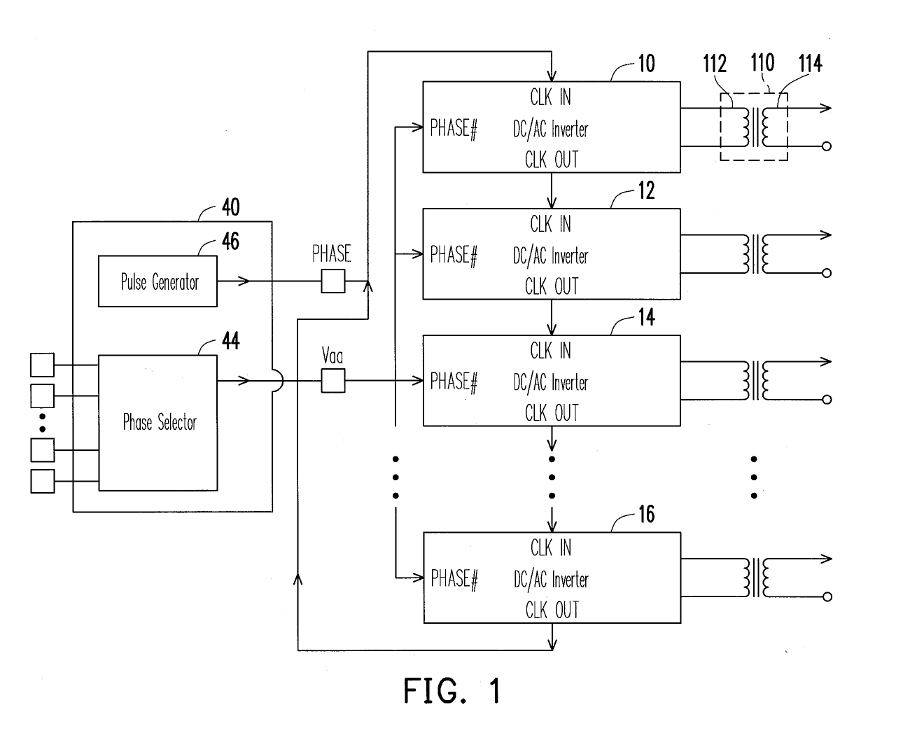

### DESCRIPTION OF THE EMBODIMENTS

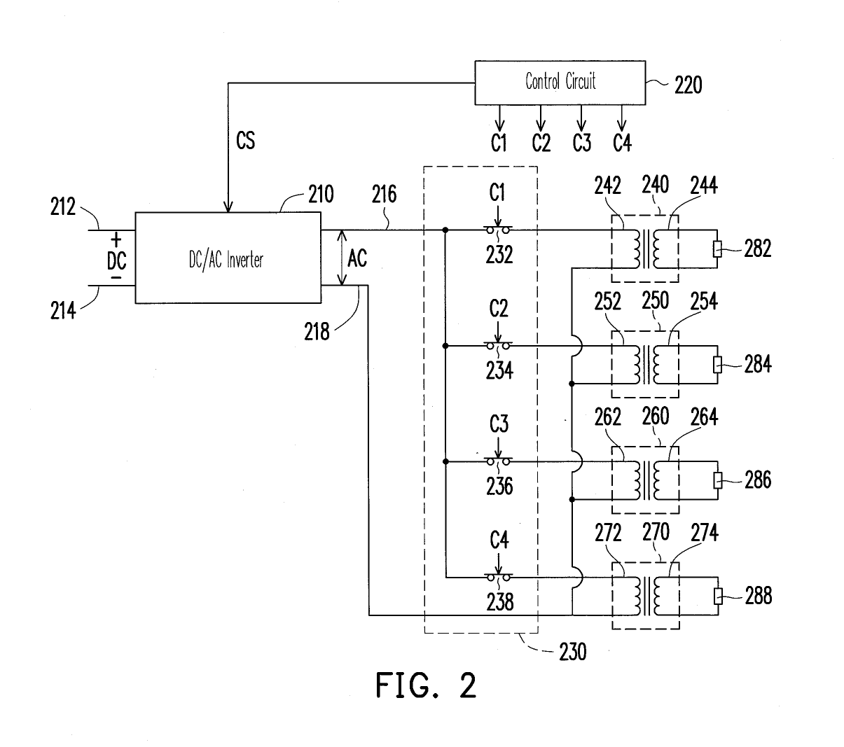

FIG. 2 illustrates a scanning driving apparatus for a backlight source according to one embodiment of the present invention. The scanning driving apparatus for a backlight source includes a DC/AC inverter 210, a control circuit 220, a switch group 230, and transformers 240, 250, 260, 270. The switch group 230 includes switches 232, 234, 236, 238. The DC/AC inverter 210 includes input terminals 212, 214 as well as output terminals 216, 218. In addition, each transformer includes a primary winding and a secondary winding. For example, the transformer 240 includes a primary winding 242 and a secondary winding 244. Each secondary winding is adapted to be connected to a load such as a cold cathode fluorescent lamp (CCFL) (as indicated by 282˜288).

It is to be noted that, in the present embodiment, each of the switches 232, 234, 236, 238 operates in a normally-on-mode. As shown in the drawing, each of the switches electrically connects the output terminal 216 to the output terminal 218 through a corresponding one of the primary windings. For example, the switch 232 electrically connects the output terminal 216 to the output terminal 218 through the primary winding 242. The control circuit 220 is used to generate control signals C1˜C4 and output the control signals to the switches 232, 234, 236, 238, respectively, so as to control temporary and periodic turn-off on these switches in a predetermined sequence according to these control signals. Besides, in the present embodiment, the control circuit 220 is further used to output a control signal CS to the DC/AC inverter 210 to thereby control turn-on and turn-off on the DC/AC inverter 210.

Once activated, the DC/AC inverter 210 converts a direct current (DC) voltage received at its input terminals 212, 214 into an alternate current (AC) voltage outputted via its output terminals 216, 218. As such, it can be determined whether to transmit the AC voltage outputted from the DC/AC inverter 210 to the primary winding of a corresponding one of the transformers and hence whether to turn on a corresponding one of the CCFLs by controlling turn-on or turn-off on each switch. Therefore, the backlight source can be driven in a scanning driving method. In addition, the whole circuit needs only one DC/AC inverter, thereby significantly reducing the size and cost of the circuit.

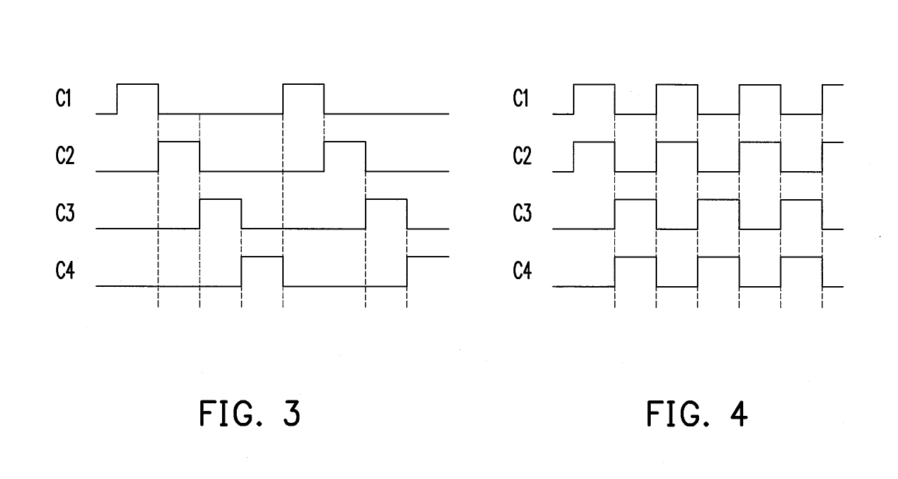

FIG. 3 illustrates one sequence of the control signals C1˜C4 of FIG. 2. Referring to FIGS. 2 and 3, in brief, when the control signal is in a low voltage level, the corresponding switch is turned on. On the contrary, when the control signal is in a high voltage level, the corresponding switch is turned off. As can be seen from the sequence in FIG. 3, the switches 232, 234, 236 and 238 are turned off in the sequence as mentioned, and only one switch is turned off at a time. In other words, the CCFLs 282, 284, 286 and 288 are turned off in a sequence in which the switches 232, 234, 236 and 238 are turned off. As such, the CCFLs 282˜288 can be driven with a scanning driving method.

Alternatively, the control circuit 220 may also control temporary turn-off on the switches such that two switches are turned off each time, as discussed below with reference to FIG. 4. FIG. 4 illustrates another sequence of the control signals C1˜C4 of FIG. 2. Referring to FIGS. 2 and 4, in brief, when the control signal is in a low voltage level, the corresponding switch is turned on. On the contrary, when the control signal is in a high voltage level, the corresponding switch is turned off. As can be seen from the sequence of FIG. 4, the switches 232, 234, 236, 238 are classified into two groups which are turned off alternately. That is, two switches are turned off at a time. In other words, CCFLs 282, 284, 286, 288 of respective groups are turned off alternately. Therefore, the CCFLs 282, 284, 286, 288 can be driven with another scanning driving method.

While four transformers and four switches are used in the example illustrated in FIG. 2, it is to be understood, however, the apparatus of FIG. 2 could use N transformers and N switches, where N is a natural number. In addition, while in the example described with reference to FIGS. 2 and 4, temporary turn-off on the switches are controlled such that two switches are turned off each time, it is to be understood, however, the control circuit 220 could control temporary turn-off on the switches such that K switches are turned off each time when the scanning backlight source driving apparatus includes N switches, where K is also a natural number and N/K is an integer.

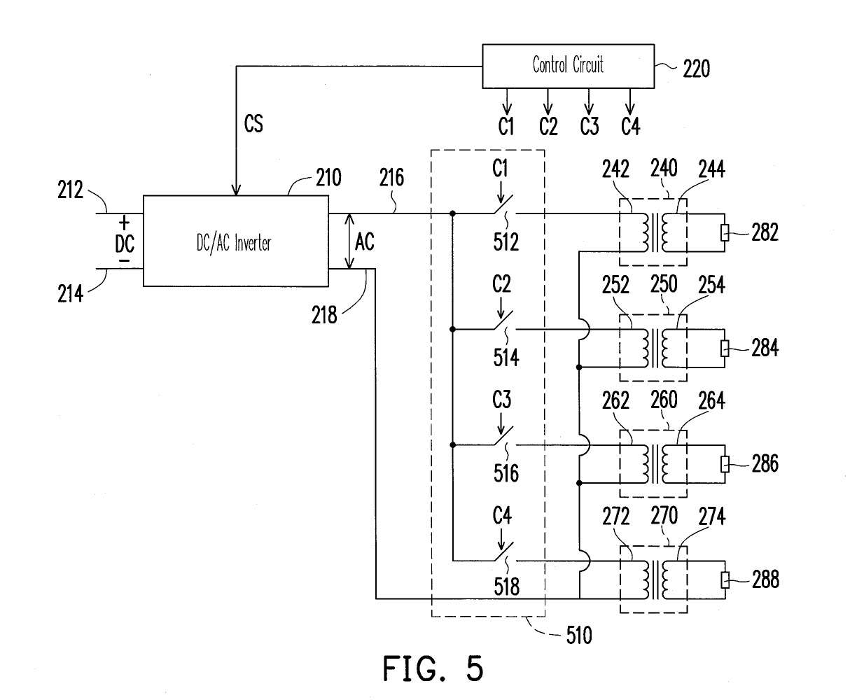

While the switches 232, 234, 236, 238 operate in a normally-on-mode illustrated in FIG. 2, it would be appreciated by those skilled in the art that the invention could also be practiced with these switches operating in a normally-off-mode as discussed with reference to FIG. 5. FIG. 5 illustrates a scanning driving apparatus for a backlight source according to another embodiment of the present invention. As shown in FIG. 5, each switch in a switch group 510 is normally in a turn-off state and is used to determine whether to electrically connect the output terminal 216 to the output terminal 218 through a corresponding one of the primary windings. The control circuit 220 is used to control periodic and temporary turn-on on the switches in a predetermined sequence according to the control signals C1˜C4.

The control signals C1˜C5 of FIG. 5 may be discussed using the sequence shown in FIG. 3. Referring to FIGS. 5 and 3, in brief, when the control signal is in a low voltage level, the corresponding switch is turned off. On the contrary, when the control signal is in a high voltage level, the corresponding switch is turned on. As can be seen from the sequence of FIG. 3, the switches 512, 514, 516, 518 are turned on in the sequence as mentioned, and only one switch is turned on at a time. In other words, the CCFLs 282, 284, 286, 288 are turned on in the sequence in which the switches 512, 514, 516, 518 are turned on. Therefore, the CCFLs 282, 284, 286, 288 can be driven with another scanning driving method.

Alternatively, the control circuit 220 of FIG. 5 may also control temporary turn-on on the switches such that two switches are turned on each time, in which case the control signals C1˜C4 can be discussed using the sequence shown in FIG. 4. Referring to FIGS. 4 and 5, in brief, when the control signal is in a low voltage level, the corresponding switch is turned off. On the contrary, when the control signal is in a high voltage level, the corresponding switch is turned on. As can be seen from the sequence of FIG. 4, the switches 512, 514, 516, 518 are classified into two groups which are turned on alternately. That is, two switches are turned on at a time. In other words, CCFLs 282, 284, 286, 288 of different groups are turned on alternately. Therefore, the CCFLs 282, 284, 286, 288 can be driven with another scanning driving method.

While four transformers and four switches are used in the example illustrated in FIG. 5, it is to be understood, however, the apparatus of FIG. 5 could use N transformers and N switches, where N is a natural number. In addition, while in the example described with reference to FIGS. 4 and 5, the control circuit 220 controls the temporary turn-on on the switches such that two switches are turned on each time, it is to be understood, however, the control circuit 220 could control temporary turn-on on the switches such that K switches are turned on each time when the scanning backlight source driving apparatus includes N switches, where K is also a natural number and N/K is an integer.

It is to be noted that each of the switches may be implemented as an electronic switch element or a mechanical switch element. The electronic switch element may be a bilateral switch, and the mechanical switch element may be a relay.

In summary, in embodiments of the present invention, the scanning backlight source driving apparatus includes a DC/AC inverter, N transformers, N switches, and a control circuit. Turn-on/turn-off on each switch is used to determine whether to transmit an AC voltage outputted from the DC/AC inverter to the primary winding of a corresponding one of the transformers. By using the control circuit to control turn-on/turn-off on the switches, the backlight source can be driven with a scanning driving method, and the whole circuit needs only one DC/AC inverter, thereby significantly reducing the size and cost of the circuit.

Besides, if a liquid crystal display employs the scanning backlight source driving apparatus of the present invention, i.e., the liquid crystal display includes a display panel as sell as the scanning backlight source driving apparatus illustrated in one of FIG. 2 and FIG. 5, the cost of the liquid crystal display can be significantly reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A scanning driving apparatus for a backlight source, comprising:
a DC/AC inverter having a first output terminal and a second output terminal configured to output an AC voltage;
N transformers each having a primary winding where N is a natural number;
N switches each electrically connecting the first output terminal to the second output terminal through a corresponding one of the primary windings; and
a control circuit configured to control periodic and temporary turn-off on the switches in a predetermined sequence.

2. The scanning driving apparatus for a backlight source according to claim 1, wherein the control circuit is configured to control temporary turn-off on the switches such that K switches are turned off each time, where K is a natural number and N/K is an integer.

3. The scanning driving apparatus for a backlight source according to claim 1, wherein the control circuit is configured to control turn-on and turn-off on the DC/AC inverter.

4. The scanning driving apparatus for a backlight source according to claim 1, wherein each of the switches includes an electronic switch element or a mechanical switch element.

5. The scanning driving apparatus for a backlight source according to claim 4, wherein the electronic switch element includes a bilateral switch and the mechanical switch element includes a relay.

6. A scanning driving apparatus for a backlight source, comprising:
a DC/AC inverter having a first output terminal and a second output terminal configured to output an AC voltage;
N transformers each having a primary winding where N is a natural number;
N switches each configured to determine whether to electrically connect the first output terminal to the second output terminal through a corresponding one of the primary windings; and
a control circuit configured to control periodic and temporary turn-on on the switches in a predetermined sequence.

7. The scanning driving apparatus for a backlight source according to claim 6, wherein the control circuit is configured to control temporary turn-on on the switches such that K switches are turned on each time, where K is a natural number and N/K is an integer.

8. The scanning driving apparatus for a backlight source according to claim 6, wherein the control circuit is configured to control turn-on and turn-off on the DC/AC inverter.

9. The scanning driving apparatus for a backlight source according to claim 6, wherein each of the switches includes an electronic switch element or a mechanical switch element.

10. The scanning driving apparatus for a backlight source according to claim 9, wherein the electronic switch element includes a bilateral switch and the mechanical switch element includes a relay.

11. A liquid crystal display, comprising:
a display panel; and
a scanning driving apparatus for a backlight source, comprising:
a DC/AC inverter having a first output terminal and a second output terminal configured to output an AC voltage;
N transformers each having a primary winding where N is a natural number;
N switches each electrically connecting the first output terminal to the second output terminal through a corresponding one of the primary windings; and
a control circuit configured to control periodic and temporary turn-off on the switches in a predetermined sequence.

12. A liquid crystal display, comprising:
a display panel; and
a scanning driving apparatus for a backlight source, comprising:
a DC/AC inverter having a first output terminal and a second output terminal configured to output an AC voltage;
N transformers each having a primary winding wherein N is a natural number;
N switches each configured to determine whether to electrically connect the first output terminal to the second output terminal through a corresponding one of the primary windings; and
a control circuit configured to control periodic and temporary turn-on on the switches in a predetermined sequence.
